(19) United States
(12) Patent Application Publication
(10) Pub. No.: US 2012/0040135 A1
(43) Pub. Date: Feb. 16, 2012

(54) Sandwich Panel, Support Member for Use in a Sandwich Panel and Aircraft Provided with Such a Sandwich Panel

(76) Inventors: Jon Micheal Werthen, Tulsa, OK (US); Jan Willem Gunnink, Nieuwekerk a/d IJssel (NL); Joseph William Evancho, Gibsonia, PA (US)

(21) Appl. No.: 13/140,400

(22) PCT Filed: Dec. 4, 2009
(86) PCT No.: PCT/NL2009/050740

§ 371 Date: Oct. 21, 2011

(30) Foreign Application Priority Data
Dec. 4, 2008 (NL) NL2002289

(51) Int. Cl. B32B 3/00

(52) U.S. Cl. 428/138; 428/189

(57) ABSTRACT

The invention relates to a sandwich panel, comprising two skin layers and, connected thereto, a core layer in between. The first skin layer extends beyond the core at an edge of the panel by a protruding part, thereby defining an open edge space of the panel. The panel is further provided with a support member for the protruding part, the support member having a first part, extending inside the open edge space, and having a second part extending outside the open edge space and up to the plane, defined by the outer surface of the first skin layer. The panel provides an improved delamination resistance. The invention also relates to a support member for use in a sandwich panel according to the invention, and to a vehicle, in particular an aircraft, provided with the sandwich panel.

### FIELD OF THE INVENTION

The present invention relates to a sandwich panel. The invention also relates to a support member for use in such a sandwich panel. The invention further relates to aircraft provided with such a sandwich panel, and to an assembly of two panels comprising the support member.

### BACKGROUND OF THE INVENTION

Sandwich panels are used in a wide variety of applications, such as in vehicles or aircraft, and may be subject to extensive requirements regarding weight and strength. Sandwich panels combine stiffness and strength with low weight. Such sandwich panels are for instance described in US2007/0054087 A1, and comprise two skin layers and, connected thereto, a core layer in between. Typically an adhesive is used to connect the skin layers to the core. This connection may be critical, especially in case the core shows a low contact surface for connection to the skin layers, such as with a core made from honeycomb or (porous) foam. Loads, and in particular impact loads, applied at the edges of sandwich panels may result in delamination of the skin layers from the core. Such loads typically occur in aircraft floor panels at the junction of two adjacent panels, for instance when a loaded trolley is pushed across the junction. Particularly damaging loads include those that have a component perpendicular to the first skin layers surface. Partly delaminated floor panels may require expensive and time-consuming repair or even replacement operations. Down-time for aircraft is particularly expensive and therefore to be avoided.

Several solutions have been proposed to solve the above mentioned problem. These solutions all aim to improve the bonding strength between skin layers and core, either by increasing the contact surface between skin and core, or by developing improved bonding adhesives. Although improved adhesives, such as the polyamides disclosed in US2007/0054087 A1, may increase the bonding strength between the skin layers and the core, edge delaminations of sandwich panels due to impact loads at these edges still occur too frequently, which lowers the average life span of such floor panels.

In accordance with the present invention, a sandwich panel is provided that has a longer life span than the known sandwich panel, such as the one described in US2007/0054087 A1.

In addition a support member for use in a sandwich panel is provided.

In another aspect of the invention, an aircraft or other vehicle provided with a sandwich panel according to the invention is provided.

In yet another aspect of the invention, an assembly of two panels comprising the support member is provided.

### SUMMARY OF THE INVENTION

In accordance with the present invention a sandwich panel is provided, comprising two skin layers and, connected thereto, a core layer in between, wherein a first skin layer extends beyond the core at an edge of the panel by a protruding part, thereby defining an open edge space of the panel, the panel being further provided with a support member for the protruding part, the support member having a first part that extends inside the open edge space, and a second part that extends outside the open edge space and at least up to the plane, defined by the inner surface of the first skin layer. By providing the sandwich panel with the support member of the invention, delamination of skins and core is less likely to occur as compared to the known sandwich panel, and in particular delamination of the first skin layer and the core. Since the second part of the support member, i.e that part that extends outside the open space, extends at least up to the plane, defined by the inner surface of the first skin layer, impact loads are transferred to the support member and to a lesser extent to the first skin layer.

The first skin layer is typically the skin layer that is directly contacted by impact loads, and corresponds to the top layer of a sandwich floor panel for instance. The sandwich panel may also be a wall panel, in which case the first skin layer will generally correspond to the front side of the wall panel. The open edge space of the sandwich panel of the invention is defined as the space delimited by the planes defined by:
the inner surface of the first skin layer;
the inner surface of the second skin layer;
the core layer; and
a closing plane that extends from the edge surface of the protruding part of the first skin layer, perpendicular to the outer surface of the first skin layer.
   The open edge space is accessible to objects, such as the support member of the present invention.

In a preferred embodiment, the sandwich panel according to the invention is characterized in that the second part of the support member extends a distance beyond the plane, defined by the inner surface of the first skin layer, of at least 25% of the thickness of the first skin layer, more preferably at least 50% of the thickness of the first skin layer, and most preferably at least 75% of the thickness of the first skin layer.

In an even more preferred embodiment, the sandwich panel according to the invention comprises a second part of the support member that extends a distance beyond the plane of between 25% and 175% of the thickness of the first skin layer, more preferably of between 50% and 150% of the thickness of the first skin layer, and most preferably of between 75% and 125% of the thickness of the first skin layer. The support member may in these embodiments form a raised edge, which may provide additional protection to the panel, but may be impractical when the panel is used as a floor panel, since the raised edge then forms an obstacle for rolling objects such as aircraft catering trolleys for instance. In an embodiment having a raised edge, the second part of the support member may comprise a flange, which partly covers the outer surface of the first skin layer.

Preferably, when the support member extends beyond the open space and beyond the plane, defined by the outer surface of the first skin layer, the support member comprises a flange, extending over the outer surface of the skin layer. The flange may be formed together with the first and second part of the support member. When inserting the support member into the open edge space, the preformed flange then slides over the outer surface of the first skin layer into its final position. The flange is preferably formed by bending or folding a part of the second part that extends beyond and out of the plane over the outer surface of the first skin layer, after the support member has been inserted into the open edge space of the sandwich panel.

Particularly preferred is a sandwich panel wherein the second part of the support member extends up to the plane, defined by the outer surface of the first skin layer. In such embodiment, a surface of the support member coincides with the plane defined by the outer surface of the first skin layer, thereby forming a levelled common surface.

In another embodiment of the invention, the second part of the support member, (i.e. the ‘outside’ part) extends up to the edge surface of the protruding part of the first skin layer. A smooth transition between two adjacent panels is hereby achieved, which is particularly advantageous for floor panels. Also, the risk for delamination is further reduced.

In yet another embodiment, the second part of the support member extends up to the plane defined by the outer surface of the second skin layer. When inserting such an embodiment of the support member into the open edge of a sandwich panel, the outer surfaces of both skin layers and of the support member will align or level and therefore form a smooth surface. An aircraft trolley therefore will not experience any difficulty in going from one panel to another.

In a further embodiment of the invention, the second skin layer extends beyond the core at an edge of the panel by a protruding part and the first and/or second part of the support member extend up to the inner surface of the second skin layer. In this embodiment, loads applied to the support member are transferred away from the first skin layer and also partly transferred to the second skin layer. This may further improve the life span of the panel.

In yet another embodiment of the invention, the first part of the support member (i.e. the ‘inside’ part) extends up to the inner surface of the protruding part of the first skin layer. This provides an increased support of the protruding part of the first skin layer and a further reduced risk for delamination.

In a particularly preferred embodiment of the invention, the first part of the support member extends up to the core layer of the sandwich panel. In this embodiment, loads applied to the support member are at least partly transferred to the core layer as well, which core layer will predominantly experience compression loads, which is favourable.

In an even more preferred embodiment of the invention, the shape of the first part of the support member substantially conforms to the shape of the open edge space, such that when inserting the support member into the edge space, the support member is actually guided to take its optimal position, which, according to the invention, is the position wherein the second part (that part that extends outside the open edge space) will extend up to the plane, defined by the outer surface of the first skin layer.

Preferably the first and second part of the support member are integrally formed, for instance by extrusion or compression molding. An integrally formed support member is better able to transfer loads, is stronger and stiffer, is readily produced, and moreover is easily handled and positioned at the edge of a sandwich panel.

The sandwich panel according to the invention may comprise a protruded skin layer along a part of the edge only. The support member likewise may extend along a part of an edge of the sandwich panel only. In a preferred embodiment however, at least one skin layer of the sandwich panel extends beyond the core substantially along an entire edge of the panel by a protruding part. In such an embodiment, the support member preferably also extends along said entire panel edge, and moreover has a constant cross-section along this edge.

According to the invention, a plurality of support members may be inserted in one or more than one open edge space(s) of a panel. The use of multiple support members along an edge of a panel allows for easier insertion of the support members.

The support member can have any shape in cross-section, as long as it has the features claimed by the present invention. Since the support member should at least partly be insertable in the open edge space of a sandwich panel, the support member will in most cases be a slender member, with a longitudinal dimension substantially larger than the cross-section dimensions. In a preferred embodiment the support member comprises a cavity. This saves weight and still provides stiffness and thus low deformation of the panel, also at the edges thereof. Preferably the cavity extends along substantially the entire length of the support member, which may, if desired be provided with end closures.

In the preferred embodiment of a support member having a central cavity, the walls of the cross-section thereof may be continuous and therefore completely enclose the cavity, or they may be discontinuous and therefore comprise an opening. The opening in the side wall(s) of the cross-section of the support member may face in the direction of the core or away from the core, the latter being preferred since the support member in this preferred embodiment finds a good support against the core layer of the sandwich panel. Preferably the opening extends along substantially the entire length of the support member. This saves weight and still provides sufficient stiffness and resistance against delamination. In addition, an opening in the support member facing away from the core will generally facilitate insertion of the support member into the open edge space of the sandwich panel.

In another embodiment the support member has a constant wall thickness. Such support member is easy to manufacture and distributes loads more evenly.

In a particular preferred embodiment of the invention, a connection member is provided aimed at connecting two adjacent sandwich panels, which connection member is shaped substantially conformably to the inside surface of the support members of adjacent panels, such that it can be inserted in the openings of support members of the adjacent panels. If multiple floor panels are combined to build a floor, good connection may be achieved by positioning such connection members in the openings of the adjacent support members. In the connected state, the opening of a first support member typically faces towards the opening of a second support member, the connection member extending at least partly in both openings. Such a connection member is also useful in levelling two adjacent sandwich panels, without actually fixating both panels.

In a further preferred embodiment of the invention, the support member is at least partly bonded to the inner surface of the protruding part of at least the first skin layer. A load applied to the support member and especially applied to the edge of the support member will at least partly be carried by the bond and transferred further away as a shear force. Preferably, the support member is bonded across the entire inner surface of the protruding part of at least the first skin layer. This further reduces the risk of delamination, and also the consequences of a delamination.

The skin layers of the sandwich panel according to the invention may comprise any suitable material. The skin layers may comprise metals such as aluminum, steel, titanium, and alloys thereof. Preferably at least one skin layer comprises a composite material, build up of reinforcing fibers, embedded in a thermosetting and/or thermoplastic matrix. Composite materials combine light weight with high strength, fatigue resistance and damage tolerance. Reinforcing fibers to be suitably applied in the skin layers include for example glass fibers, carbon fibers and metal fibers, and also drawn thermoplastic polymer fibers, such as aramid fibers (Kevlar®), poly(p-phenylene-2, 6-benzobisoxazole) fibers (PBO, Zylon®), poly(2,6-diimidazo-(4,5b-4′,5′e)pyridinylene-1,4(2,5-dihydroxy)phenylene) fibers (better known as M5® fibers), and ultrahigh molecular weight polyethylene or polypropylene fibers, and/or combinations of the above fibers. Examples of suitable matrix materials for the reinforcing fibers are thermoplastic polymers such as polyamides, polyimides, polyethersulphones, polyetheretherketone, polyurethanes, polyethylene, polypropylene, polyphenylene sulphides (PPS), polyamide-imides, acrylonitrile butadiene styrene (ABS), styrene/maleic anhydride (SMA), polycarbonate, polyphenylene oxide blend (PPO), thermoplastic polyesters such as polyethylene terephthalate, polybutylene terephthalate, as well as mixtures and copolymers of one or more of the above polymers. Suitable matrix materials also comprise thermosetting polymers such as epoxies, unsaturated polyester resins, melamine/formaldehyde resins, phenol/formaldehyde resins, polyurethanes, and the like.

A particularly preferred embodiment of the sandwich panel according to the invention comprises skin layers of fiber metal laminates, such as Glare® and/or Arall®. Fiber metal laminates are layered structures, comprising layers of metal, such as aluminium, and layers of reinforcing fibers embedded in a suitable matrix. Fiber metal laminates are particularly preferred since they not only resist high impact loads, but also fatigue loading conditions. Moreover, it was observed that the support member of the invention in particular performs well in suppressing delamination, when used in combination with a first skin layer comprising a fiber metal laminate. Suitable reinforcing fibers and matrixes for use in the fiber metal laminates include those given above for a skin layer of composite material.

A particularly preferred fiber metal laminate comprises fiber-reinforced composite layers and thin metal sheets, wherein the total metal volume fraction of the laminate is between 0 vol. % and 47 vol. %, more preferably between 5 vol. % and 41 vol. %, even more preferably between 10 vol. % and 35 vol. %, and most preferably between 15 vol. % and 30 vol. %.

The outer surface of at least one skin layer may be smooth. The outer surface may also be textured, for example formed with a diamond-shaped pattern, to provide for increased friction properties of the outer surface.

The core layer of the sandwich panel according to the invention may likewise comprise various materials. Preferably the core layer is made from structures selected from the group containing honeycomb, lightweight foam and balsawood. Such structures combine lightweight with high stiffness. A preferred honeycomb structure comprises a material selected from the group containing metals, such as aluminium, polymers, and/or paper. Honeycomb structures based on these materials are easily manufactured, and cheap. The honeycomb structure may also comprise aramid fibers and/or sheets, such as Nomex®, which provides flame resistance. A preferred foam structure comprises metal, and/or plastics, such as thermoset and thermoplastics. The core layer may also be obtained by pultrusion. Yet another option is to built the core layer from layers of corrugated sheet and/or parallelly arranged stringers, such as hat-, Z- or C-stringers.

The support member of the invention may also comprise various materials. Suitable material include metals, such as aluminium, steel, titanium, plastics, fiber reinforced composites, and even fiber metal laminates. Preferably the support member comprises a polymer, preferably a thermoplastic material. Polymers allow for easy manufacturing of the support member by extrusion or compression moulding for instance, and are generally cheap. The support member may also be manufactured by an extrusion process or formed, for example by deforming a flat sheet.

The invention also relates to a support member for use in a sandwich panel according to the invention, more preferably for use in a sandwich floor panel according to the invention, and most preferably for use in a sandwich floor panel comprising a first skin layer of a fiber metal laminate, according to the invention.

The invention further relates to a method for assembling a support member with a sandwich panel, the method comprising taking away a part of the core layer at least along part of the edge of a panel, thereby providing the panel with an open edge space, inserting a support member according to the invention with its first part into the open edge space, and preferably fixating the support part to the panel with a fixating agent such as an adhesive, nails, screws, and the like.

The invention further relates to a vehicle, comprising at least one panel according to the invention. The vehicle may be a bus, a ship, and preferably an aircraft or spacecraft. For aircraft and spacecraft to be functional they need to be light and strong. Panels according to the present invention may be advantageously used in such vehicles.

### BRIEF DESCRIPTION OF THE DRAWINGS

FIG. 1—Shows a perspective view of a sandwiched floor panel according to the state of the art.

FIG. 2—Shows a perspective exploded view of the floor panel of FIG. 1.

FIG. 3—Shows a perspective view of a sandwiched floor panel according to the invention.

FIGS. 4A-4G—Show cross-sections of different embodiments of sandwiched floor panels according to the invention.

FIG. 5A—Shows a cross-section of two sandwiched floor panels according to the invention, connected by a connecting member.

FIG. 5B—Shows a perspective view of the two sandwiched floor panels of FIG. 5a.

### DETAILED DESCRIPTION OF THE INVENTION

In the following description, reference is made to the accompanying drawings, which form a part hereof, and which show, by way of illustration, specific embodiments in which the invention may be practiced. The present invention, however, may be practiced without the specific details or with certain alternative equivalent embodiments that those described herein.

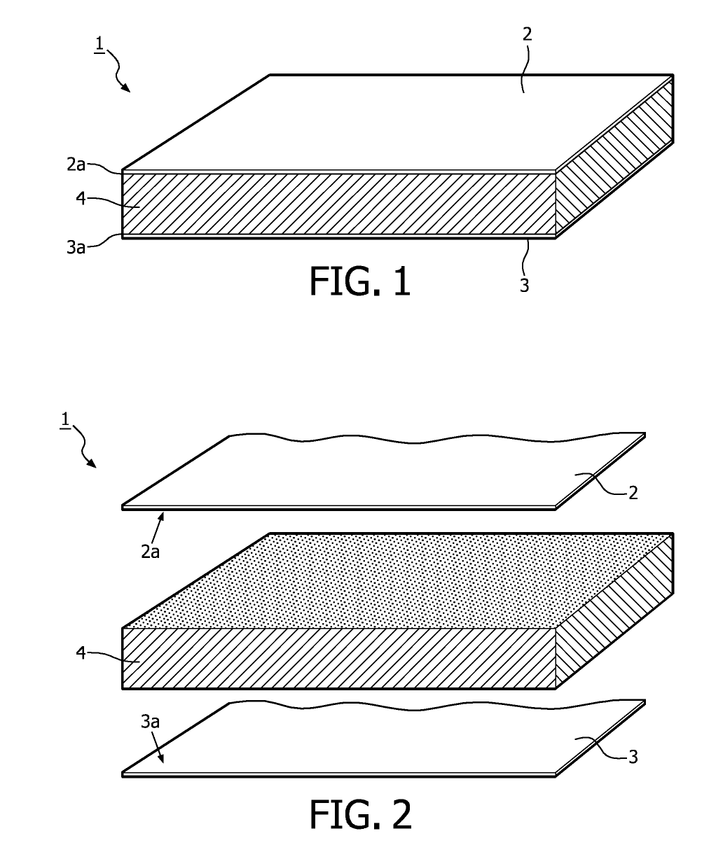

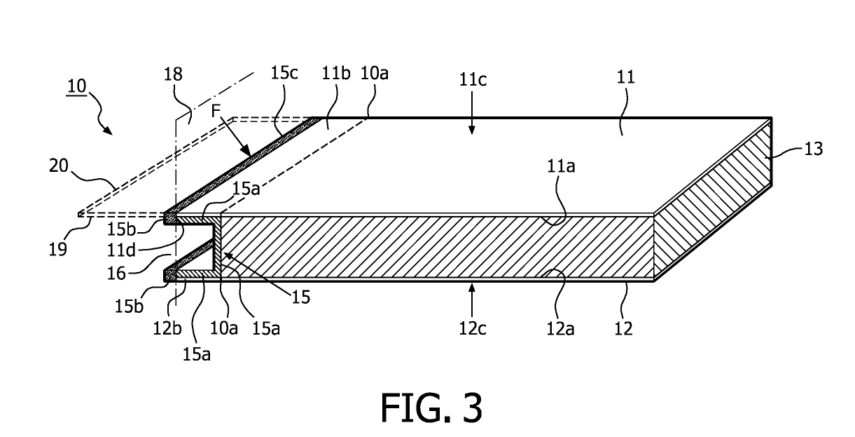

FIG. 1 shows a floor panel 1 according to the state of the art. The floor panel 1 is built up of a first skin layer 2, which corresponds to the top layer of the floor panel, and a second skin layer 3, which corresponds to the bottom layer. In between the top layer 2 and bottom layer 3 a core 4 is positioned. The core 4 is adhered to the inner surface 2a of the top layer 2 and to the inner surface 3a of bottom layer 3. The top layer 2, bottom layer 3 and core 4 have equal length and width. For clarity purposes, FIG. 2 shows an exploded view of the floor panel 1 of FIG. 1.

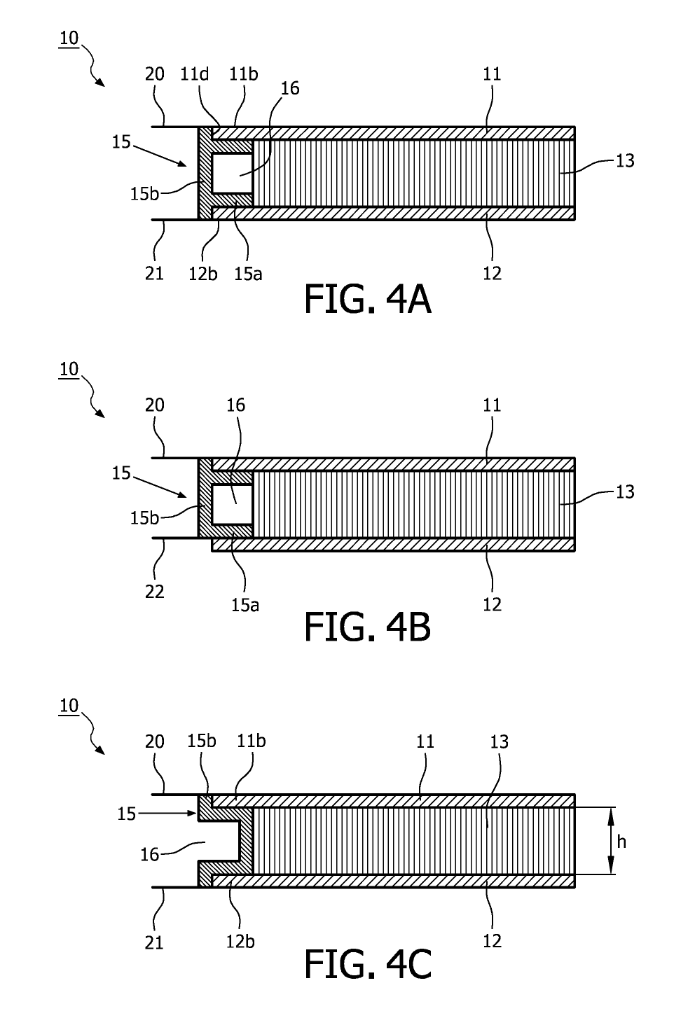

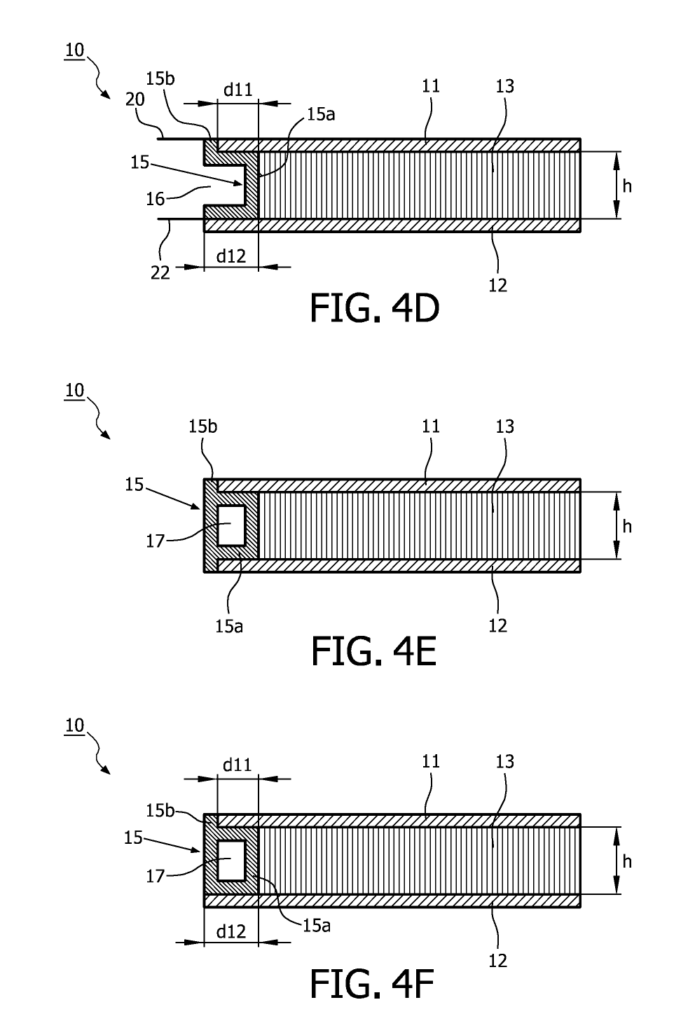

FIG. 3 shows a perspective view on a floor panel 10 according to the invention. The floor panel 10 is built up of a first skin layer 11, which is the top layer in this case, and a second skin layer 12, which corresponds to the bottom layer of the floor panel 10. The top and bottom layer are constructed as fiber-metal laminates, comprising layers of aluminium and layers of glass-fibers, embedded in an epoxy resin matrix. In between the top layer 11 and bottom layer 12 is positioned a core 13, constructed as a honeycomb structure made from thin aluminium sheets (not shown in detail in FIG. 3). The core 13 is adhered to the inner surface 11a of the top layer 11, and the inner surface 12a of the bottom layer 12, using an epoxy based adhesive. The top layer 11 and the bottom layer 12 extend beyond the core 13 at an edge by protruding parts (11b, 12b) of the first and second skin layers (11, 12) respectively. A support member 15 is provided for supporting the protruding part 11b of skin layer 11. Support member 15 comprises a first part 15a that extends in an open edge space of the panel 10, created by protruding parts (11b, 12b) (this first part 15a is parallel hatched in FIG. 3). The open edge space is delimited by the planes defined by the inner surfaces (11a, 12a) of the first and second skin layers (11, 12) respectively, the edge 10a of core layer 13, and a closing plane 18 perpendicular to the outer surface 11c of the first skin layer 11. A second part 15b of the support member 15 extends outside the open edge space and up to the plane, defined by the outer surface of the first skin layer 11 (this second part 15b is crosshatched in FIG. 3). The support member 15 extends along the edge of the floor panel 10 and comprises an opening 16, facing away from the core 13. In the embodiment shown, the support member 15 extends fully to the inner surfaces of protruding parts (11b, 12b) of the first and second skin layers (11, 12) respectively, and to the edge 10a of core 13, such that its shape conforms tot the shape of the open edge space, as defined above. When inserting support member 15 into the edge opening of floor panel 10, support member 15 will be guided such that it takes a position wherein the second part 15b extends up to the plane 20, defined by the outer surface 11c of the first skin layer 11 (see also FIGS. 4A-4F).

An impact load F, for instance induced by an aircraft servicing trolley and applied to the edge 15c of the support member 15 is transferred into the support member 15, away from the first skin layer 11 and into the core 13 and the second skin layer 12.

Referring to FIG. 4A, an embodiment of the floor panel 10 of FIG. 3 is shown. The second part 15b of the support member 15 extends beyond the open space and up to the planes (20, 21), defined by the outer surfaces of both the first and second skin layers (11, 12). The support member 15 comprises an opening 16 facing the core layer 13. The first part 15a of the support member 15 is bonded to the inner surfaces of the protruding parts (11b, 12b) of the first and second skin layers (11, 12), respectively, as well as to the core 13.

The support member 15 from FIG. 4B differs from the one shown in FIG. 4A in that the second part 15b of the support member 15 extends beyond the open space and up to the plane 20, defined by the outer surface of the first skin layer 11 and to the plane 22 defined by the inner surface of the second skin layer 12.

The support member 15 from FIG. 4C differs from the one shown in FIG. 4A in that the support member 15 comprises an opening 16 facing away from the core 13, and in that the first part 15a of the support member 15 contacts the core layer 13 over the height h of the core layer 13.

The support member 15 from FIG. 4D differs from the one shown in FIG. 4A in that the support member 15 extends beyond the open space and up to the plane 20, defined by the outer surface of the first skin layer 11 and to the plane 22 defined by the inner surface of the second skin layer 12, in that it the opening 16 is facing opposite from the core 13 and in that the first part 15a of the support member 15 contacts the core layer 13 over the height h of the core layer 13. Additionally the length d12 of the protruding part 12b of the second skin layer 12 is larger than the length d11 of the protruding part 11b of the first skin layer 11.

The support member 15 from FIG. 4E differs from the one shown in FIG. 4A in that the support member 15 comprises a cavity 17 and in that the first part 15a of the support member 15 contacts the core layer 13 over the height h of the core layer 13.

The support member 15 from FIG. 4F differs from the one shown in FIG. 4A in that the support member 15 extends beyond the open space and up to the plane 20, defined by the outer surface of the first skin layer 11 and to the plane 22 defined by the inner surface of the second skin layer 12, in that it comprises a cavity 17, in that the first part 15a of the support member 15 contacts the core layer 13 over the height h of the core layer 13. Additionally the length d12 of the protruding part 12b of the second skin layer 12 is larger than the length d11 of the protruding part 11b of the first skin layer 11.

The support member 15 from FIG. 4G differs from the one shown in FIG. 4A in that the second part 15b of the support member 15 extends beyond the open space and beyond the plane 20, defined by the outer surface of the first skin layer 11. The support member 15 comprises a flange 15c, extending over the outer surface of the skin layer 11. The flange may be formed together with the first and second part 15a,15b of the support member 15, when the flange is an integral part of the second part 15b of the support member 15. During insertion of the support member 15 into the open edge space, the flange 15c then slides over the outer surface of the first skin layer 11. The flange 15c may also be formed by bending or folding a part of the second part 15b that extends beyond and out of the plane 20 over the outer surface of the first skin layer 11, after the support member 15 has been inserted into the open edge space of the floor panel 10.

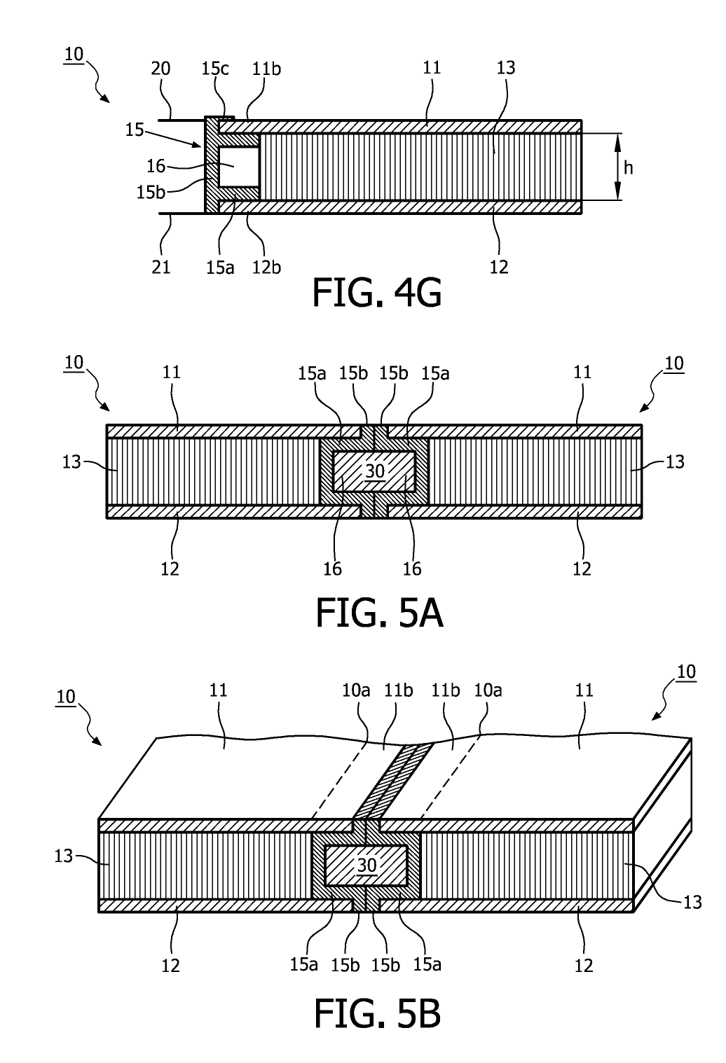

FIG. 5A shows a cross-section of two sandwiched floor panels 10 according to the invention. The floor panels are positioned such that each edge 10a of the floor panels face each other. Both floor panels comprise a support member 15 as shown in FIG. 4C. The second parts 15b of the support members 15 of both floor panels 10a contact each other. The openings 16 of both support members 15 face opposite from their corresponding core layers 13 and as a result the openings 16 face towards each other. A connecting member 30 is positioned between the floor panels 10 and extends in the two openings 16, which openings 16 face each other. For clarity purposes, FIG. 5B shows a perspective view on the two floor panels 10 of FIG. 5B.

The sandwich panel and support member according to the invention are particularly useful in vehicles such as trucks, aircraft, trains, and the like, particularly air- or spacecraft, in applications such as wall and floor panels, the latter being particularly preferred. The support member according to the invention provides strong and light weight sandwich panels with a reduced risk for delamination.

1. Sandwich panel (10), comprising two skin layers (11, 12) and, connected thereto, a core layer (13) in between, wherein a first skin layer (11) extends beyond the core (13) at an edge of the panel by a protruding part (11b), thereby defining an open edge space of the panel (10), wherein the panel (10) is provided with a support member (15) for the protruding part (11b), the support member (15) having a first part (15a), extending inside the open edge space, and having a second part (15b) extending outside the open edge space and at least up to the plane (19), defined by the inner surface (11a) of the first skin layer (11).

2. Sandwich panel according to claim 1, characterized in that the second part (15b) of the support member (15) extends a distance beyond the plane (19) of at least 25% of the thickness of the first skin layer (11), more preferably of between 50% and 150% of the thickness of the first skin layer (11), and most preferably of between 75% and 125% of the thickness of the first skin layer (11).

3. Sandwich panel according to claim 1, characterized in that the second part (15b) of the support member (15) extends up to the plane (20), defined by the outer surface (11c) of the first skin layer (11).

4. Sandwich panel according to any one of the preceding claims, characterized in that the second part (15b) of the support member (15) extends up to the edge surface (11d) of the protruding part (11b) of the first skin layer (11).

5. Sandwich panel according to claim 1 or 2, characterized in that the support member (15) comprises a flange (15c), extending over the outer surface (11c) of the skin layer (11), the flange 15c being formed by bending or folding a part of the second part (15b) that extends beyond and out of the plane (20) over the outer surface of the first skin layer (11), after the support member (15) has been inserted into the open edge space of the panel.

6. Sandwich panel according to any one of the preceding claims, characterized in that the first part (15a) of the support member (15) extends up to the inner surface (11a) of the protruding part (11b) of the first skin layer (11).

7. Sandwich panel according to any one of the preceding claims, characterized in that the shape of the first part (15a) of the support member (15) substantially conforms to the shape of the open edge space.

8. Sandwich panel according to any one of the preceding claims, characterized in that the first and second part (15a, 15a) of the support member (15) are integrally formed.

9. Sandwich panel according to any one of the preceding claims, characterized in that the support member (15) comprises a cavity (16).

10. Sandwich panel according to any one of the preceding claims, characterized in that the support member is bonded to at least the inner surface (11a) of the protruding part (11b) of the first skin layer (11).

11. Sandwich panel according to any one of the preceding claims, characterized in that at least one skin layer comprises a composite material.

12. Sandwich panel according to claim 11, characterized in that the composite material is a fiber metal laminate, comprising layers of metal and layers of reinforcing fibers embedded in a matrix resin.

13. Support member for use in a sandwich panel according to any one of the preceding claims.

14. Assembly of sandwich panels according to any one of the preceding claims, the assembly comprising a connection member (30) aimed to connect support members of adjacent panels.

15. Aircraft, comprising a sandwich panel or a support member according to any one of the preceding claims.
